(19) United States
(12) Patent Application Publication
(10) Pub. No.: US 2013/0007615 A1
(43) Pub. Date: Jan. 3, 2013

(54) COMPUTER-IMPLEMENTED MEAL PREPARATION GUIDE

(76) Inventor: Jane Goldman, San Francisco, CA (US)

(21) Appl. No.: 13/174,722

(22) Filed: Jun. 30, 2011

(51) Int. Cl. G06F 3/01

(52) U.S. Cl. 715/709

(57) ABSTRACT

A computer-implemented meal planning guide is provided to facilitate users in preparing meals in which multiple food items (e.g., dishes) or courses are to be provided. The meal planning guide may be implemented in a variety of computing environments, such as on a computing device of the user (e.g., tablet, mobile device, laptop or personal computer), web-environment or combination thereof.

### TECHNICAL FIELD

Embodiments described herein pertain to a computer-implemented meal preparation guide.

### BACKGROUND

Recipes and cooking programs are abundant in society. Recipes are often available from mediums such as books and online libraries. In conventional use, recipes facilitate individuals in preparing a food item or dish. For meal preparation in which multiple dishes and courses are to be served, persons utilize multiple recipes. Typically, the experience and knowledge of the preparer is needed to coordinate the preparation of multiple dishes for serving at one time.

### BRIEF DESCRIPTION OF THE DRAWINGS

FIG. 1 illustrates a system for providing a meal preparation guide, according to one or more embodiments.

FIG. 2A illustrates a method for providing a meal preparation guide, according to one or more embodiments.

FIG. 2B illustrates an output in which individual instructional steps for preparing selected food items of a meal are presented according to a timeline or schedule, according to an embodiment.

FIG. 3A illustrates a presentation for a meal preparation guide, according to one or more embodiments.

FIG. 3B illustrates a presentation for enabling a user to select food items that are to be prepared for a meal, according to an embodiment.

FIG. 4A illustrates a food item preparation guide, according to one or more embodiments.

FIG. 4B illustrates instructional steps for preparing a food item as part of a meal, according to an embodiment.

FIG. 4C illustrates equipment used for preparing a food item as part of a meal, according to an embodiment.

FIG. 5A through FIG. 5C illustrate a recipe guide for preparing a particular food item, according to an embodiment.

FIG. 6 illustrates a shopping list for use in a meal preparation guide, according to an embodiment.

FIG. 7 illustrates a presentation that lists instructional steps for preparing multiple food items as part of a meal over the course of multiple time periods, according to an embodiment.

FIG. 8 illustrates a computing system on which one or more embodiments may be implemented.

### DETAILED DESCRIPTION

Embodiments described herein provide a computer-implemented meal planning guide to facilitate users in preparing an entire meal that comprises several food items.

Embodiments described herein recognize that meal preparation can pose several challenges that can hinder the successful preparation of a meal. Among the challenges, complex meals (e.g., ones requiring multiple dishes or courses) are difficult for some to sequence and time in preparation, at least in a manner that would ensure the various food items are completed at an appropriate time relative to when the meal is to be served. Even when recipes are used, the steps recited in the individual recipes are difficult to sequence and time. Moreover, complex meals often require considerable preparation in advance.

Embodiments described herein provide a computer-implemented guide that facilitates users in preparing complex meals. Among other features, embodiments provide (i) recipes for the preparer, (ii) sequence or schedule steps from multiple recipes in so that the individual food items are completed at an appropriate time relative to the meal completion time, and/or (iii) list items the preparer needs in advance of preparing the meal.

According to some embodiments, a computer-implemented meal planning guide is provided to facilitate users in preparing meals in which multiple food items (e.g., dishes) or courses are to be provided. The meal planning guide may be implemented in a variety of computing environments, such as on a computing device of the user (e.g., tablet, mobile device, laptop or personal computer), web-environment or combination thereof.

In an embodiment, preparation information is maintained for each of a plurality of food items. The preparation information for each food item includes (i) a set of instructional steps and (ii) a set of ingredients for preparing the food item. A selection is received from the user for a set of food items that is to be provided as part of a meal that the user is to prepare. From the preparation information of the food items selected, a timeline or schedule is determined for preparing each food item in order to complete the meal at a particular completion time. The computer-implemented meal planning guide presents the user with individual instructional steps for preparing each food item of the set. The instructional steps are presented in accordance with the timeline or schedule.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried out and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

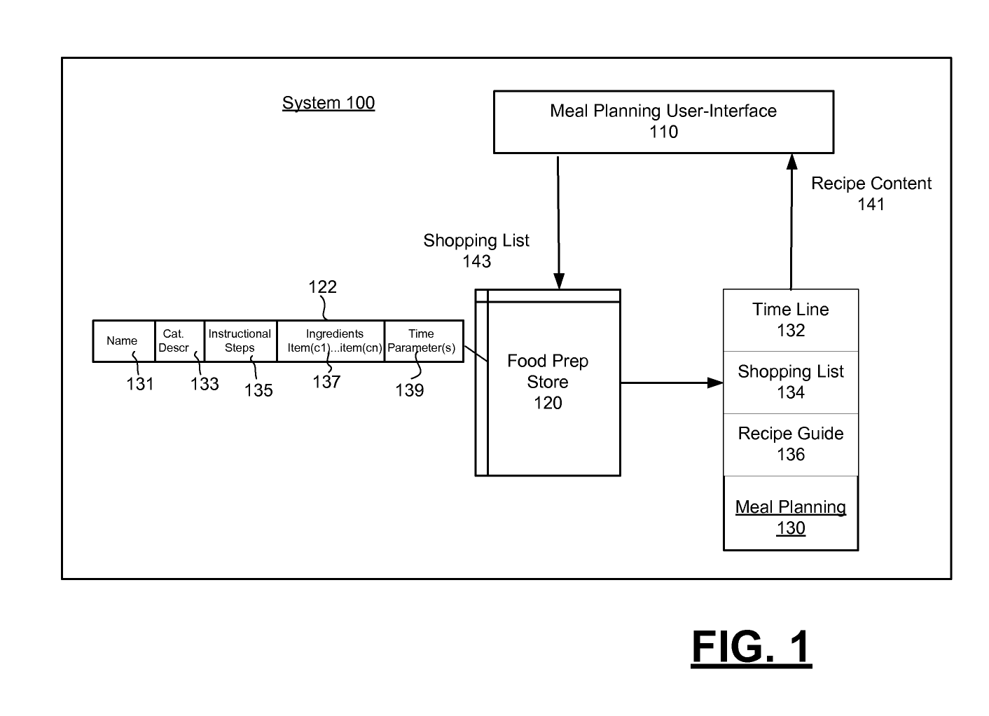

FIG. 1 illustrates a system for providing a computer-generated meal preparation guide, according to one or more embodiments. A system 100 includes a meal planning user interface 110, a food preparation data store 120, and a meal planning component 130. The system 100 can be implemented in a variety of computing environments. In one implementation, system 100 is implemented as a computer program that the user executes on a computing device, such as a tablet, mobile device or personal computer. In some variations, the system 100 can be implemented in a network environment, such as a website that the user can access using a browser or web-enabled application. In such implementations, system 100 can be implemented through a commercial web browser or web-based application.

According to some embodiments, the food preparation data store 120 stores a library of preparation instructions for preparing food items. Individual food items specified in the food preparation data store 120 can correspond to, for example, an entrée, an appetizer or starter dish, a dessert, a soup or salad, or a sauce. As used herein, a meal can comprise multiple food items, served at different times over the course of a meal. For example, a holiday meal can comprise a primary plate or entrée (e.g., turkey or ham), side dishes (e.g., mashed potatoes, boiled potatoes, stuffing, string beans, etc.), multiple starter items (e.g., soup, salad and appetizer) and dessert (e.g., pie).

In one embodiment, records 122 in the food preparation data store 120 identify food items by name (e.g., name of recipe or dish) 131, category or descriptors (e.g., starter dish, dessert, ethnic categorization) 133, instructional steps to prepare the food item 135 (e.g., recipe), ingredients of the food item 137, and timing parameters 139. Examples of food items for which preparation information is maintained includes starter dishes (e.g., soups, salads, appetizers), primary meal dishes (e.g., baked ham or turkey), side dishes (e.g., mashed potatoes, beans), sauces (e.g., gravy) and desserts (e.g., pie). The timing parameter 139 specifies when specific instruction steps are to be performed (e.g., recipe steps) relative to, for example, a completion time for the entire meal.

The interface 110 is configured to generate features that enable the user to select food items that are to comprise a specific meal. In one embodiment, the interface 110 enables the user to select recipes for a particular meal, such as a holiday meal (e.g., Thanksgiving). The user can, for example, select recipes for side dishes, the main platter or entrée (e.g., ham or turkey), sauces (e.g., gravy), starter dishes (e.g., soup) or dessert. In a variation, the user can specify all facets of the meal, including the entrée, side dishes, starter plates and dessert.

The interface 110 can be configured to enable the user to select food items for meal preparation by, for example, enabling the user to view, browse or search recipes or descriptions of food items. The interface 110 can display, for example, a menu from which the user can make selections in order to specify the components of the meal. As another example, the interface 110 can include search fields or category designations to enable the user to browse for food items by category (e.g., starter dishes, by ethnicity, nutrition or ingredient). Still further, the interface 110 can make suggestions to the user based on some user selections. For example, the food preparation data store 120 can include popular dishes, or track what dishes experts or other users select in connection with, for example, entrées or events (e.g., popular side dishes for turkey dinner).

According to one or more embodiments, the meal planning component 130 includes functionality corresponding to timeline determination 132, shopping list determination 134, and recipe guide 136. The meal planning component 130 generates output responsive to, for example, user input and/or programming requirements. The output can be provided as, for example, a series of presentations that are displayed to the user through the interface 110. Among other content, the output can include presentations for (i) preparing individual food items, (ii) preparing food items under a meal planning schedule in which an entire meal is completed on a schedule, and (iii) a shopping list for food items and/or a meal. In one embodiment, the recipe guide 136 generates recipe content 141 that includes content (e.g., text and images) corresponding to, for example, recipe steps or directions. The instructional steps of the recipe content 141 can recite ingredients, measurements, and text for how a particular step is to be performed. Additional content, such as an image of the recipe step (during or after completion), can also be shown.

According to embodiments, the timing parameter 139 is associated with instructional steps for each selected food item. The timing parameter 139 is utilized in presenting how individual steps that the user needs to perform are to be sequenced or timed in order for the user to successfully prepare each food item of the meal at an appropriate time (e.g., time relative to when the entrée is to be served).

In an embodiment, the recipe content 141 presents the instructional steps of the various food items in a manner that reflects a timeline for which specific actions (as provided for by the instructional steps) are to be performed. The timeline reflected in the recipe content 141 for the various instructional steps may be determined from the timeline determination component 132. In an embodiment, the timeline determination component 132 utilizes timing parameters 139 associated with individual instructional steps (or sets thereof) for selected food items in order to present sequencing and/or timing information as to when the specific instructional steps are to be performed, relative to when the meal is to be served. Among numerous other considerations, the pertinent timeline for a meal may consider (i) how many courses are to be provided in the meal, with appetizers and starter dishes being served hot or cold; (ii) which food items of the various courses need to be served hot or chilled; and/or (iii) which food items are to be served immediately when ready, as opposed to which need to be cooled, chilled, allowed to gel, etc. The result is that the recipe content 141 presents the instructional steps in a manner that guides the user into being able to, for example, (i) prepare and serve appetizers/starter dishes at the appropriate temperature and time, before the entrée is served; (ii) prepare and serve items that comprise the entrée (including side dishes), which may need to be served hot once the starter dish is consumed by the those participating in the meal; or (iii) prepare a food item that needs to be combined with other food items and initiated sufficiently in advance to enable the combination to take place (e.g., placing stuffing in turkey, preparing vegetables for stew, etc.). Given such requirements, the timeline determination component 132 can be used to specify timing/sequencing information in connection with how the various instructional steps are to be performed by the user in order for the various food items of the meal to be served at appropriate times and temperatures.

In various embodiments, the timing parameter 139 is referenced relative to a meal completion time. The meal completion time is a known or assumed parameter. For example, the meal completion time may be specified by user input, or designated by a default parameter. The meal completion time may further be specified as a relative parameter. For example, rather than corresponding to a specific time, the meal completion time may coincide with when the primary entrée is to be served.

As an example, the timing parameter 139 associated with recipe steps for preparing a turkey may specify that the turkey is to be defrosted and brined days in advance of the meal. Furthermore, instructional steps for preparing stuffing may specify that initial steps are performed for a designated duration (e.g., hours in advance) of the meal completion time. During the food preparation session (e.g., two hours prior to the serving of the appetizer), the recipe content 141 may further specify, based on corresponding timing parameters 139, that steps for multiple food items are performed concurrently (e.g., simmer sauce, bake green beans and glaze ham). Based on the timing parameters 139, the recipe content may, for example, instruct the preparer to initiate the boiling of an item early on in the preparation session, and further to initiate sauce simmering late in the session. In this way, the preparation of the various food items is performed at appropriate times so that each food item is completed at the appropriate time for the meal.

In addition to recipe content 141, the shopping list 134 of the meal planning component 130 can identify the ingredients and quantities of the food items that are to be prepared. The shopping list 143 may list the ingredients of the recipes of all food items selected by the user in formulating a shopping list 143. The shopping list 143 may be presented to the user via the interface 110. Alternatively, the shopping list may be communicated to the user through other means, such as, for example, via a messaging platform (e.g., email, SMS, social networking message (SNS), instant message (IM)). Additionally, category and/or other information can be used to categorize or sort the shopping list 143 to facilitate the user in locating ingredients.

Methodology

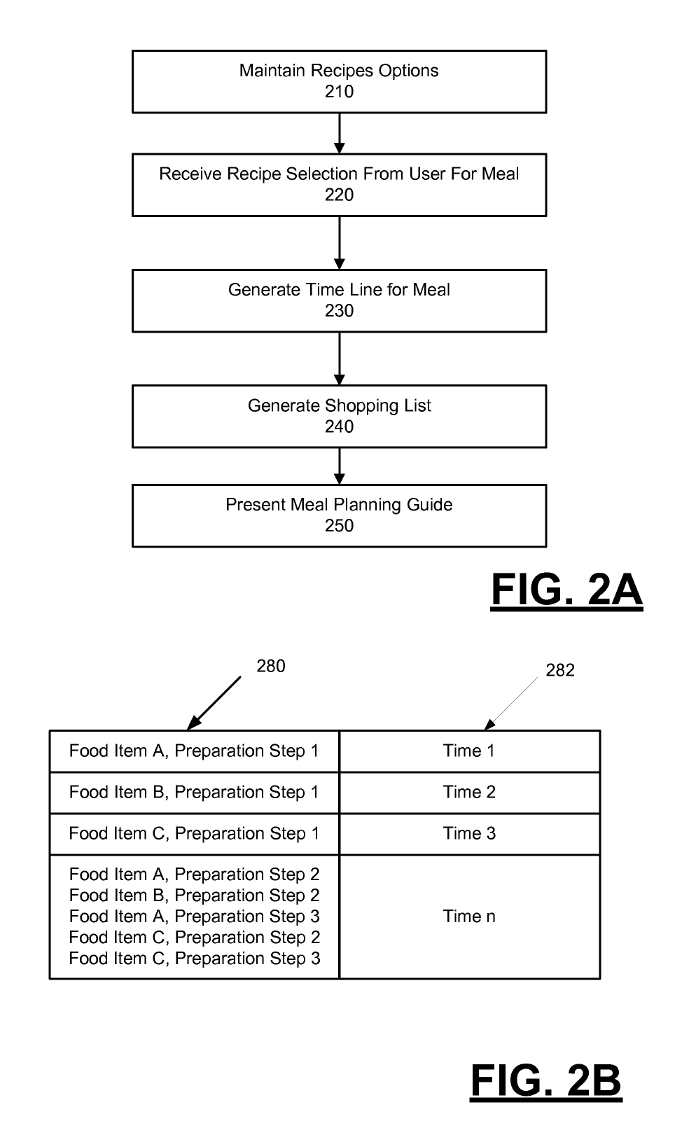

FIG. 2A illustrates a method for providing a meal preparation guide, according to one or more embodiments. A method such as described with FIG. 2A may be implemented using, for example, a system such as described with an embodiment of FIG. 1. In describing a method of FIG. 2A, reference may be made to elements of FIG. 1 for the purpose of illustrating suitable components for performing a step or sub-step being described.

In an embodiment, the food preparation store 120 stores food preparation instructions (210) for various food items that can be combined to form meals. The food preparation instructions may include, for example, recipes for various food items that can be combined with other food items to prepare a multi-course meal for parties of various sizes (e.g., 6-12 persons). The recipes may include those for starter dishes or entrées, sauces, main dishes, side dishes and desserts. Recipes can also be stored for a particular occasion or theme, such as a holiday. The stored recipes can be collected from various sources, including experts or other users.

A user can operate a computer interface to select recipes for meal preparation (220). In some implementations, the computer interface 110 is configured to guide the user selection. For example, the user may be provided a menu that identifies possible recipes for food items that comprise starter dishes, side dishes, an entrée or primary dish, and a dessert. As an alternative or variation, the interface 110 can make suggestions to the user for recipes based on user input, such as the user's specification for a primary dish or meal occasion. As alternative or additional variations, the interface 110 is configured to enable the user to search or navigate for recipes or browse for recipes by category or occasion.

As still another variation, the interface 110 can guide the user in making selections of individual food items to prepare for a meal. For example, for a party of specified size and occasion, the interface 110 may be configured to suggest a number of starter and side dishes. As additional examples, the user may suggest a theme or category (e.g., Chinese) and receive suggestions for various aspects or food items of a meal.

Once the user's recipe selection is made, a timeline or schedule is generated from which the user is to perform specific steps in individual recipes (230). The timeline or schedule can be viewed by the user in advance of the preparation. An example of a timeline or schedule is displayed with an embodiment of FIG. 2B.

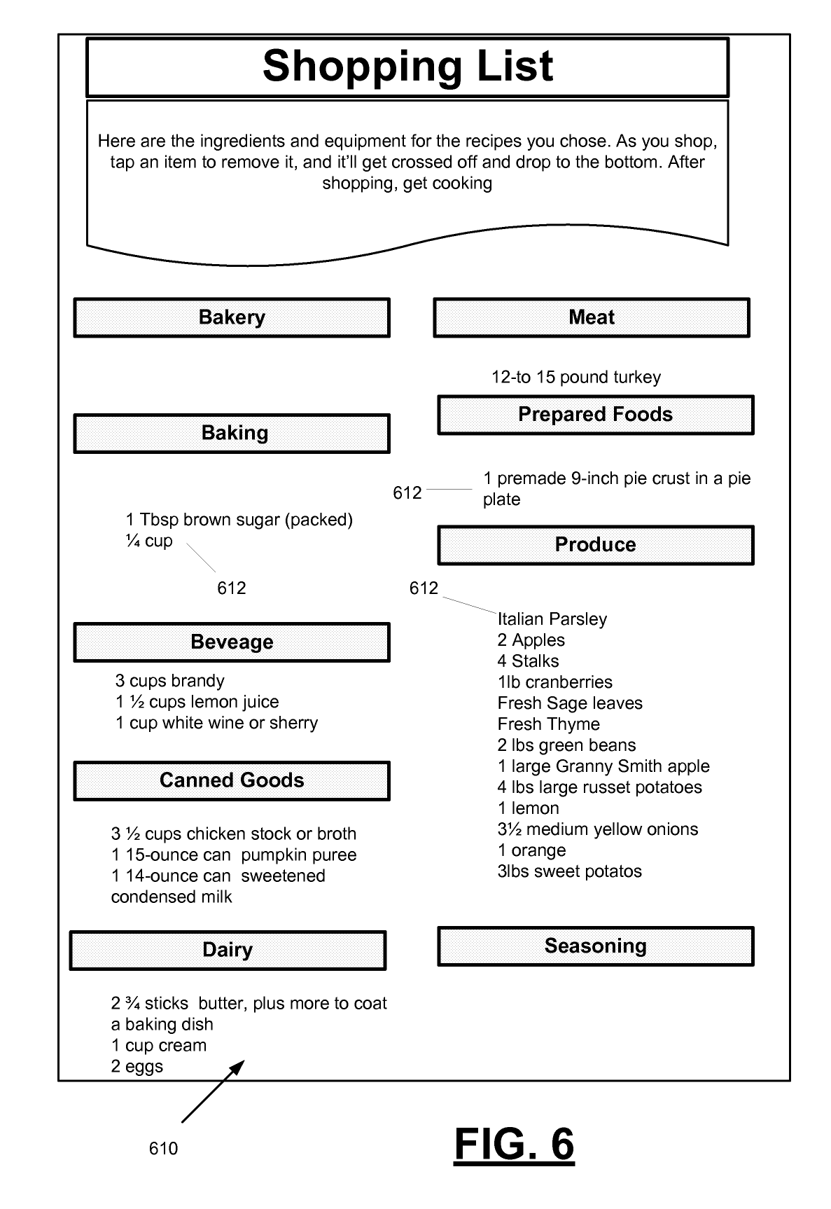

Additionally, one or more embodiments provide for generation of a shopping list to facilitate the user in procuring ingredients for preparing the selected recipes (240). In addition to ingredients, the shopping list may also identify special equipment that may be needed to perform some steps of selected recipes (e.g., a copper bowl). An example of a shopping list is displayed with, for example, an embodiment of FIG. 6.

A meal planning guide is then presented to the user (250). The meal planning guide may include instructional steps that are presented in a manner that reflects a sequence of schedule, in which individual steps from the selected recipes are performed in order to complete the various food items at an appropriate time. The meal planning guide may also display instructional steps for food items individually, display images and pictures of food items or steps to be performed (e.g., to further instruct the user), provide shopping lists, or necessary equipment lists. Other information and content may also be included with the meal planning guide.

FIG. 2B illustrates an output in which individual instructional steps for preparing selected food items of a meal are presented according to a timeline or schedule, according to an embodiment. In the example shown by FIG. 2B, recipe or preparation steps 280 are listed at scheduled intervals 282 for a selected set of food items (food items A, B, C). According to embodiments, timing parameters 139 (see FIG. 1) associated with preparation steps of individual food items are used to determine a schedule for preparing the various selected food items. The schedule identifies the intervals and/or sequence by which individual steps of the multiple recipes are to be performed in order for the various food items to be completed at an appropriate time relative to the desired or designated meal completion time. The appropriate completion time for each food item can be specific to that food item. For example, a salad that is to be served chilled may be prepared hours in advance of the meal completion time, while the main dish (which is to be served hot) may be completed at the meal preparation time. Still further, the completion time for some food items may depend on the completion of other items. For example, the final step for a primary dish (e.g., heat in sauce) may not be performed until the starter dishes are completed.

Recipe Selection

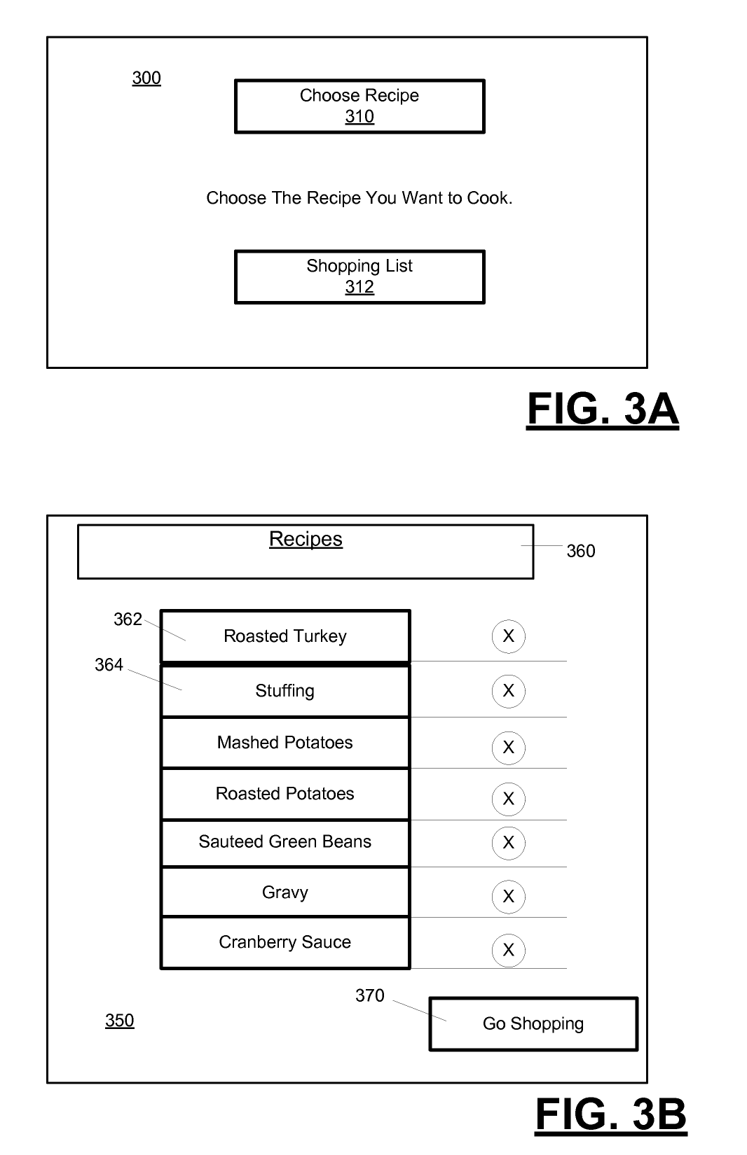

FIG. 3A through FIG. 6 illustrate preparation presentations that guide a user in selecting recipes and preparing a meal, according to one or more embodiments. The various presentations that are depicted in the examples shown can be generated through, for example, interface 110 of system 100. Accordingly, the examples provided may be generated in various computing environments, including on mobile or portable computing devices that a user can operate while shopping or cooking.

With reference in FIG. 3A, a presentation 300 is illustrated that initiates a user interaction in which recipes are selected for a meal. A feature 310 such as an icon is presented to the user in order to initiate a recipe selection process. Optionally, a shopping list feature 312 is provided to the user so that the user can view what items need to be purchased for recipes that have been selected. In this way, the user can anticipate costs and preparation complexity while selecting the recipes. Furthermore, the user can organize shopping ventures to purchase the necessary ingredients.

In FIG. 3B, a presentation 350 is depicted for enabling a user to select food items that are to be prepared for a meal, according to an embodiment. The presentation 350 may be presented to the user in response to user input to elect and to initiate the recipe selection process (e.g., selection of feature 310).

In one implementation, the user identifies the meal he or she wishes to prepare (e.g., “Thanksgiving turkey, pot roast”) at the start, and options for accompanying dishes and sauces are presented to the user. The meal selection may be designated or selected by the user. The meal the user intends to prepare may be identified generally (e.g., “Thanksgiving turkey, pot roast”) or more specifically. Additionally, the user may provide additional information that affects the recipe formulation and selection, such as the party size and/or dietary restrictions.

In the example shown by FIG. 3B, the meal is designated to be a Thanksgiving turkey. For the meal, the user is provided a feature 360 to view and select various recipes 362, 364. In the example provided, the recipe features 362, 364 are displayed to the user in list form, and the user is given the opportunity to select (or unselect) recipes for the meal. Each of the recipe features 362, 364 can be individually selected to view recipes and recipe content (e.g., images, video, instructional content, ingredients, information). When the user completes selection of the recipes, the user can select a shopping list feature 370 that generates the shopping list for the recipes selected.

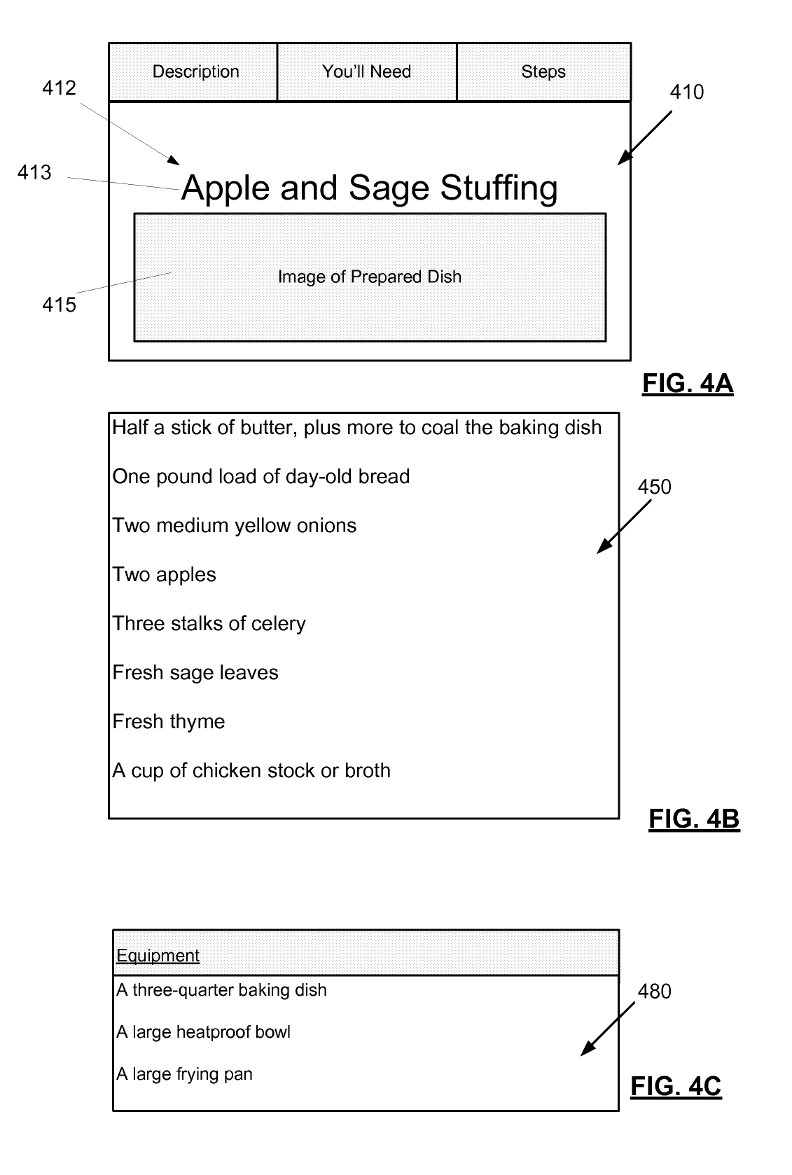

FIG. 4A illustrates a preparation presentation guide for a selected food item, according to one or more embodiments. A preparation presentation guide 410 may be displayed to the user at, for example, the selection of a corresponding one of the recipe features 362, 364. In the example shown, selection of the recipe features 362, 364 results in the display of recipe content 412, which can include text 413 and images 415 of the food item or related items. FIG. 4A thus illustrates an option in which the instructional steps for a single recipe are displayed to the user.

FIG. 4B illustrates a presentation that provides instructional steps for preparing a food item as part of a meal, according to an embodiment. The presentation 450 can be displayed to the user in response to selection of one of the recipe features 362, 364 and/or follow on presentation. The presentation can display recipe content, ingredients, tips, images, video and other information for facilitating the user's preparation of a particular food item.

FIG. 4C illustrates a presentation that lists equipment that a user is likely to need for preparing a food item as part of a meal, according to an embodiment. An equipment list 480 can be provided in addition to the recipe content to facilitate the user in preparation or recipe selection (e.g., the user can see if he or she has the equipment required for a particular recipe).

Food Preparation Guide

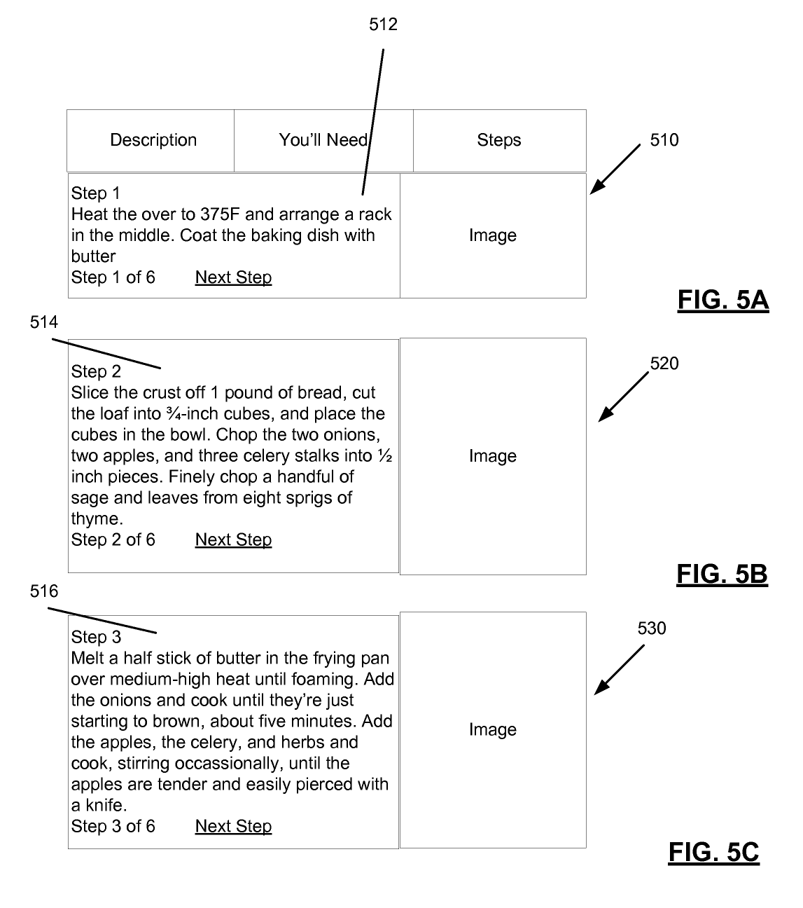

FIG. 5A through FIG. 5C illustrate a recipe guide for preparing a particular food item, according to an embodiment. According to some embodiments, system 100 generates presentations for (i) preparing individual food items, (ii) preparing a meal comprising multiple food items, in accordance with a meal planning schedule, and/or (iii) a shopping list. With reference to FIG. 5A through FIG. 5C, instructional steps can be presented to the user as a sequence of panels 510. Each panel 510 includes one or more instructional steps for preparing the food item.

In one implementation, the system 100 enables the user to view instructional (e.g., recipe) steps of each selected food item of the meal. The meal preparation component 130 may display content via the interface 110 that depicts the individual instructional steps independent of the recipe or instructional steps for the other food items that are selected for meal planning. As such, for example, the user can focus attention on one recipe item when necessary, such as to view additional information, for example, additional content (e.g., text, images, video) depicting a particular step (or its completion).

In the examples provided, a sequence of panels 510, 520, and 530 are provided that individually contain a corresponding instruction set and/or content 512, 514, 516 pertaining to a portion of a recipe for a particular food item. In sequence, the panels 510, 520, 530 communicate a complete recipe with additional content, such as images of the completed step, tips, and recommendations for other food items or equipment.

Shopping List

FIG. 6 illustrates a shopping list for use in a meal preparation guide, according to an embodiment. More specifically, when the user selects the food items that are to be prepared for the meal, a shopping list 610 for the entire meal is generated and output for the user. The shopping list 610 may be generated automatically by the shopping list functionality 134 of the meal preparation component 130. In some embodiments, the shopping list 610 is generated in response to the user's selection or identification of food items. For example, the user may make a selection of food items via the interface 110, and the shopping list 610 may be generated and output automatically via the interface 110. The shopping list 610 can be determined from the ingredient list 137 (see FIG. 1) of the preparation instructions for each selected food item.

The shopping list 610 can be updated with user re-selection of food items. For example, the user may substitute one food item for another at any point via the interface 110. In response to reselection, the shopping list 610 can be updated to reflect the ingredients of the most current selection of food items.

In one embodiment, the shopping list 610 is automatically categorized, based on categorization parameters associated with the individual ingredients of each selected food item. In particular, the shopping list 610 is categorized to better manage the user's shopping list experience.

In one implementation, the shopping list 610 is provided as an interactive panel (or panels). Each item 612 of the list 610 may be provided as an interactive feature 612. When the user acquires an item on the list, the interactive feature 612 corresponding to that item reflects the item's acquisition. For example, the interactive feature may correspond to a checkbox that is checked, or the item may be lined or grayed when acquired.

The shopping list 610 can also be generated to reflect a quantity required for a party size. For example, as described elsewhere, a user may specify a party size for a meal. The user's selection of the party size can automatically set the quantity of individual ingredients needed for each food item. The quantity of each food item may be specified or reflected in the shopping list 610.

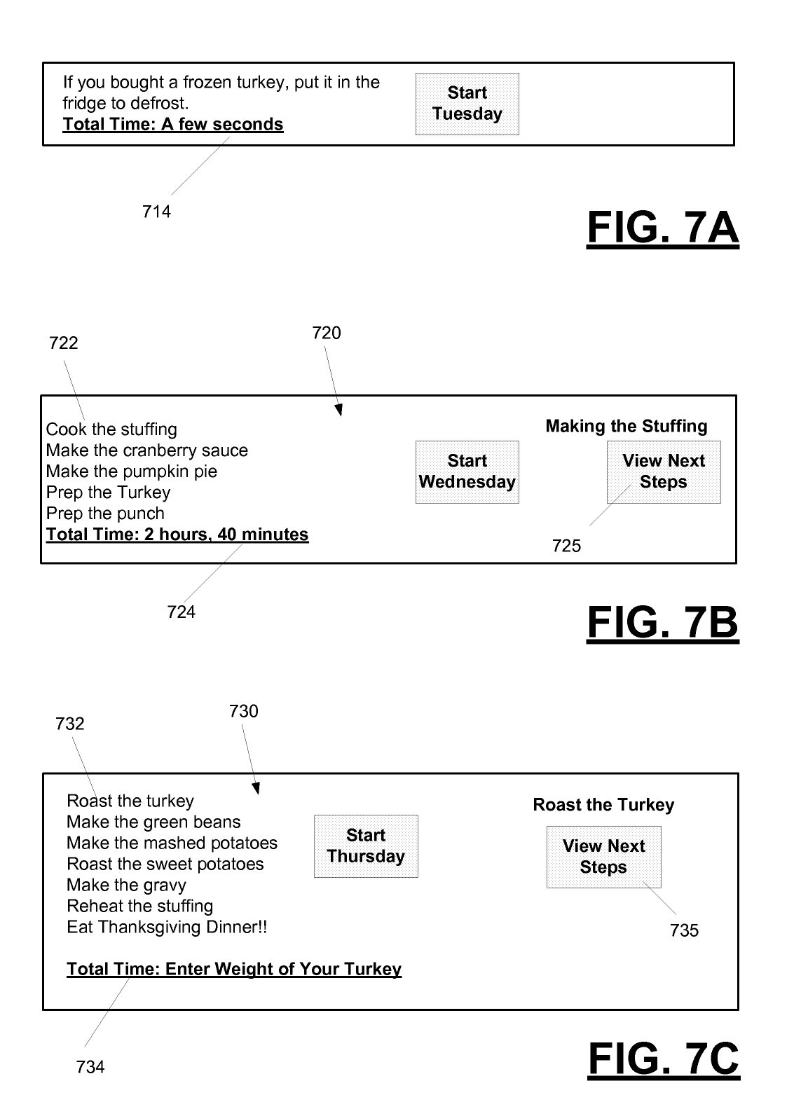

FIG. 7 illustrates a presentation that lists a timeline summary for preparing multiple food items as part of a meal over the course of multiple time periods, according to an embodiment. According to embodiments, system 100 generates the presentation in order to guide the user in advance planning of the meal preparation. The description provided for the timeline summary may identify specific time periods prior to the meal in which steps are to be performed for the meal preparation.

According to an embodiment, FIG. 7A through FIG. 7C illustrate time periods in which portions of the steps necessary for preparing the meal are performed. In FIG. 7A, a panel 710 identifies preliminary step(s) 712 and the duration 714 for performing the preliminary step (e.g., defrost turkey). In the example shown, the user can interact with the panel 710 in order to select to view next steps (such as when the user completes the steps depicted).

In FIG. 7B, a panel 720 displays summary steps 722 for preparing multiple food items at a second time interval, in advance of the meal completion time. The duration 724 for performing the steps shown is also displayed to the user, as well as the time period in which the steps are performed (e.g., “Start Wednesday”). The user can interact with the panel 720 in order to select to view next steps.

Additionally, more specific steps or instructional content that comprise the recipe of the selected food items can also be displayed to the user from the same presentation. For example, the individual summary steps 722 (e.g., “Making the stuffing”) can be presented with an interactive feature 725 that is selectable to present to the user additional information regarding the steps, sub-steps or specifics for preparing that portion of the recipe.

FIG. 7C displays a panel 730 which displays summary steps 732 for performance by the user during the food preparation session (e.g., when the user is actively in the kitchen cooking items hours before a meal). The duration 734 for performing the steps shown is also displayed to the user, so that the user can get an estimate of when he or she should start cooking prior to serving the meal. Note in the example shown, the duration 734 can be provided as an interactive feature that can determine the cooking time based on factors such as the size of the food items (e.g., weight of the turkey), or other parameters. The summary steps 732 can be presented with an interactive feature 735 that is selectable. The user may view additional instructional content for preparing each of the summary steps. In this manner, the various food items that comprise a desired meal may be prepared in a manner that ensures the individual items are prepared according to a recipe, and at an appropriate time relative to other food items of the meal.

Computer System

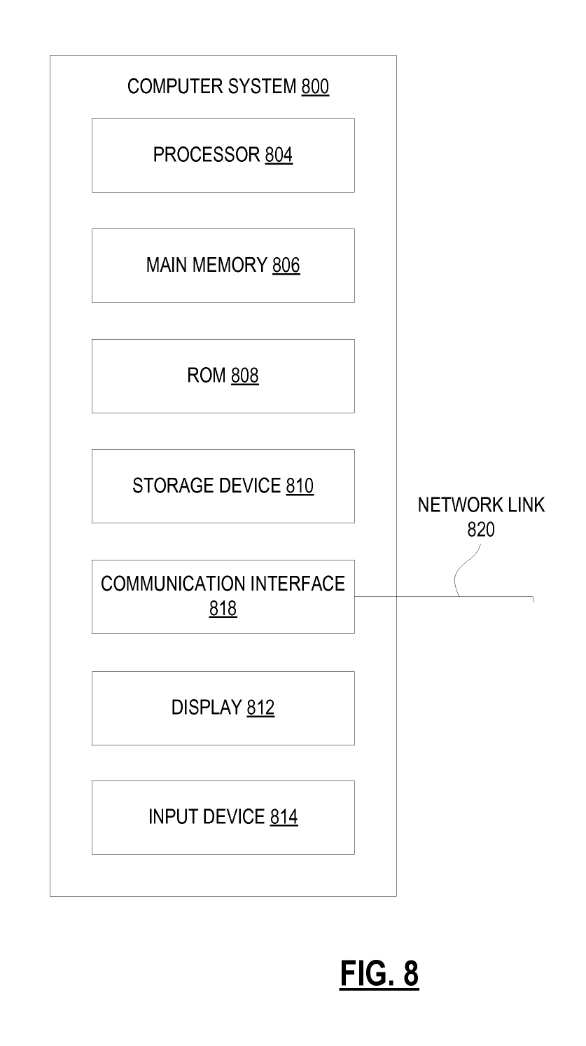

FIG. 8 is a block diagram that illustrates a computer system upon which embodiments described herein may be implemented. For example, in the context of FIG. 1, system 100 may be implemented using a computer system such as described by FIG. 8.

In an embodiment, computer system 800 includes processor 804, main memory 806, ROM 808, storage device 810, and communication interface 818. Computer system 800 includes at least one processor 804 for processing information. Computer system 800 also includes a main memory 806, such as a random access memory (RAM) or other dynamic storage device, for storing information and instructions to be executed by processor 804. Main memory 806 also may be used for storing temporary variables or other intermediate information during execution of instructions to be executed by processor 804. Computer system 800 may also include a read only memory (ROM) 808 or other static storage device for storing static information and instructions for processor 804. A storage device 810, such as a magnetic disk or optical disk, is provided for storing information and instructions. The communication interface 818 may enable the computer system 800 to communicate with one or more networks through use of the network link 820.

Computer system 800 can include display 812, such as a cathode ray tube (CRT), a LCD monitor, and a television set, for displaying information to a user. An input device 814, including alphanumeric and other keys, is coupled to computer system 800 for communicating information and command selections to processor 804. Other non-limiting, illustrative examples of input device 814 include a mouse, a trackball, or cursor direction keys for communicating direction information and command selections to processor 804 and for controlling cursor movement on display 812. While only one input device 814 is depicted in FIG. 8, embodiments may include any number of input devices 814 coupled to computer system 800.

Embodiments described herein are related to the use of computer system 800 for implementing the techniques described herein. According to one embodiment, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A computer-implemented method for guiding a user in preparing a meal, the method being implemented by one or more processors and comprising:
(a) maintaining preparation information for each of a plurality of food items, wherein the preparation information for each food item includes (i) a set of instructional steps and (ii) a set of ingredients for preparing that food item;
(b) receiving a selection from the user for a set of food items that are to be provided as part of a meal that the user is to prepare;
(c) determining, from the preparation information of each food item in the set, a timeline for preparing each food item in order to complete the meal at a particular completion time;
(d) presenting the user with individual instructional steps for preparing each food item of the set, the instructional steps being presented to reflect the timeline.

2. The method of claim 1, wherein (d) includes identifying durations of time in advance of the particular completion time in which specific instructional steps for preparing the food items of the meal are to be performed.

3. The method of claim 2, wherein identifying durations of time in advance of the particular completion time includes identifying one or more specific instructional steps that are to be performed one or more days in advance of the meal completion time.

4. The method of claim 1, wherein (b) includes receiving a user selection of a primary dish and one or more side dishes.

5. The method of claim 1, wherein (b) includes receiving a user selection of a starter plate and/or a dessert.

6. The method of claim 1, further comprising generating a shopping list for each food item in the set.

7. The method of claim 1, wherein (d) includes presenting the user with at least a portion of a recipe for each food item in the set.

8. The method of claim 7, wherein presenting the user with at least the portion of the recipe includes presenting a text and image content with each food item in the set.

9. A computing device comprising:
a memory that stores preparation information for each of a plurality of food items, wherein the preparation information for each food item includes (i) a set of instructional steps for preparing that food item, (ii) a set of ingredients for preparing the food item, and (iii) a timing parameter associated with one or more individual instructional steps to indicate when the individual instructional steps are to be initiated or performed;
one or more processors communicatively coupled to the memory, the one or more processors being configured to:
(i) enable a user to select a set of food items that are to comprise a meal that the user is to prepare;
(ii) generate an output presentation that identifies the set of instructional steps for preparing each food item in the set selected by the user, the output presentation identifying the set of instructional steps in accordance with a timeline that is based on the timing parameter associated with one or more individual instructional steps of each food item in the set selected by the user;
(iii) generate, as part of the output presentation, a shopping list for the ingredients identified in the preparation information for each food item in the set selected by the user.

10. The computing device of claim 9, wherein the one or more processors are configured to generate the output presentation in form of a plurality of slides, each of the plurality of slides presenting one or more instructional steps for preparing one or more of the food items in the set selected by the user.

11. The computing device of claim 9, wherein the one or more processors are configured to list ingredients for the shopping list by a shopping category.

12. The computing device of claim 9, wherein the output presentation presents the set of instructional steps as a recipe for individual food items selected by the user.

13. The computing device of claim 9, wherein the memory stores preparation information for food items that is to comprise a specialty meal.

14. The computing device of claim 9, wherein the one or more processors are configured to generate the output presentation to provide the timeline in multiple designated time periods, and during each of one or more time periods, a portion of the instructional steps is presented for each of multiple food items, so that the user is enabled to advance preparation of multiple food items during one or more time periods.

15. A computer-readable medium that stores computer-executable instructions for guiding a user in preparing a meal, wherein the computer-executable instructions, when executed by one or more processors, cause the one or more processors to perform steps comprising:
(a) maintaining preparation information for each of a plurality of food items, wherein the preparation information for each food item includes a set of instructional steps and a set of ingredients for preparing that food item;
(b) receiving a selection from the user for a set of food items that is to be provided as part of a meal that the user is to prepare;
(c) determining, from the preparation information of each food item in the set, a timeline for preparing each food item in order to complete the meal at a particular completion time;
(d) presenting the user with individual instructional steps for preparing each food item of the set, the instructional steps being presented to reflect the timeline.

16. The computer-readable medium of claim 15, further comprising instructions in which (d) includes identifying durations of time in advance of the particular completion time in which specific instructional steps for preparing the food items of the meal are to be performed.

17. The computer-readable medium of claim 15, further comprising instructions for identifying durations of time in advance of the particular completion time by identifying one or more specific instructional steps that are to be performed one or more days in advance of the meal completion time.

18. The computer-readable medium of claim 15, further comprising instructions in which (b) includes receiving a user selection of a primary dish and one or more side dishes.

19. The computer-readable medium of claim 15, further comprising instructions in which (b) includes receiving a user selection of a starter plate and/or a dessert.

20. The computer-readable medium of claim 15, further comprising instructions for generating a shopping list for each food item in the set.

21. The computer-readable medium of claim 15, further comprising instructions in which (d) includes presenting the user with at least a portion of a recipe for each food item in the set.

22. The computer-readable medium of claim 15, further comprising instructions in which (d) includes presenting the user with at least the portion of the recipe that includes presenting a text and image content with each food item in the set.
